(19) United States
(12) Patent Application Publication
(10) Pub. No.: US 2009/0020171 A1
(43) Pub. Date: Jan. 22, 2009

(54) Cartridge with Internal Spring

(75) Inventor: Evan Benstead, Los Angeles, CA (US)

Correspondence Address: THE BLACK & DECKER CORPORATION, 701 EAST JOPPA ROAD, TW199, TOWSON, MD, 21286, US

(73) Assignee: NEWFREY LLC, Newark, DE (US)

(21) Appl. No.: 12/174,858

(22) Filed: Jul. 17, 2008

Related U.S. Application Data
(60) Provisional application No. 60/959,818, filed on Jul. 17, 2007.

(51) Int. Cl. F16K 15/02

(52) U.S. Cl. 137/540

(57) ABSTRACT

A cartridge valve includes a housing body having a base wall and a cylindrical side wall extending from the base wall. An upper ceramic disk and a lower ceramic disk are disposed in the housing body. The lower ceramic disk, the base wall and at least a portion of the cylindrical side wall define a chamber, wherein water is allowed to fill the entire chamber.

The present application is a Continuation-In-Part of Provisional Application Ser. No. 60/959,818 filed Jul. 17, 2007.

### SUMMARY OF THE INVENTION

The present invention relates to ceramic cartridges having an internal spring biasing a pair of ceramic disks together.

### BRIEF DESCRIPTION OF THE DRAWINGS

FIG. 1 is side view of the cartridge.

FIG. 2 is an exploded view of a cartridge of FIG. 1.

FIG. 3 is a section view taken along line 3-3 in FIG. 1.

FIG. 4 is a section view through the housing body of the cartridge of FIG. 1.

FIG. 5 is a top view of the housing body.

FIG. 6 is a bottom view of a valve stem for use with the cartridge of FIG. 1.

FIG. 7 is perspective view of an upper ceramic disk for use with the cartridge of FIG. 1.

FIG. 8 is top view of the upper ceramic disk.

FIG. 9 is a perspective view of a lower ceramic disk for use with the cartridge of FIG. 1.

FIG. 10 is a bottom view of the lower ceramic disk.

FIG. 11 is illustrates an underbody for use with the cartridge of FIG. 1.

### DETAILED DESCRIPTION OF THE DRAWINGS

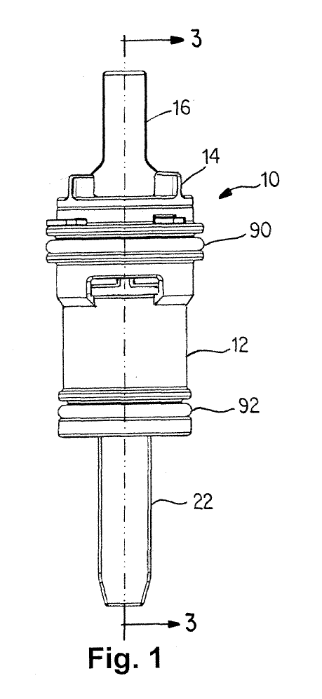

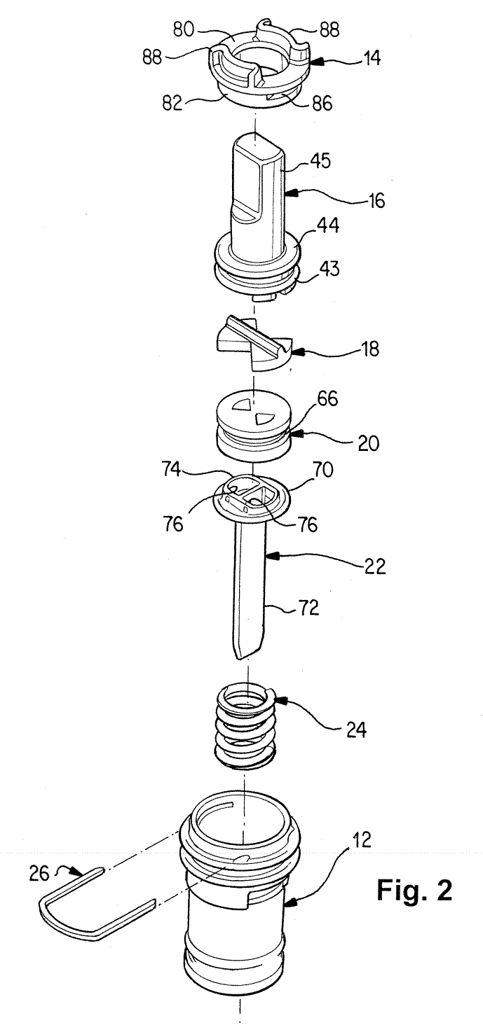

A ceramic cartridge 10 according to the present invention is illustrated in FIGS. 1-4 and includes a housing body 12, a housing top 14, a valve stem 16, an upper ceramic disk 18, a lower ceramic disk 20, a spring guide 22, a spring 24, and a retaining clip 26.

The housing body 12 includes a cylindrical side wall 30 extending vertically from a base wall 32 and terminating at an upper shoulder 33. The side wall 30 includes lower shoulder 34 located proximal to the base wall 32 and a pair of diametrally opposed water outlet openings 36 extending through the side wall 30. It further includes a pair of retaining clip-receiving bores 38 extending horizontally through the side wall 30. A plurality of spring-positioning bosses 41 extend radially inwardly from the side wall 30 and upwardly from base wall 32. The base wall 32 includes a central aperture 42 having a pair of radially-outwardly extending notches 43 for receiving the spring guide 22.

The valve stem 16, illustrated in FIGS. 1-3 and 6 includes a base portion 44 and a stem portion 45 extending vertically from the base portion 44. The base portion 44 includes an o-ring groove 43 formed in the peripheral edge 46 thereof and a pair of generally triangular recesses 48 that open radially outwardly, as illustrated in FIG. 6. The recesses 48 selectively align with the outlet openings 36 in the housing body side wall 30 when the valve stem 16 is installed in the housing body 12. The bottom surface 46 further includes a diametral slot 50 configured to receive the upper ceramic disk 18.

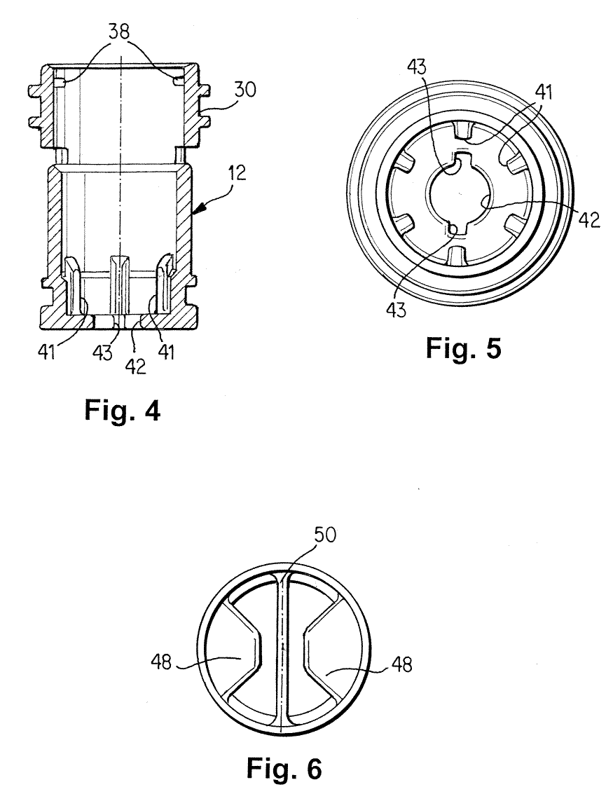

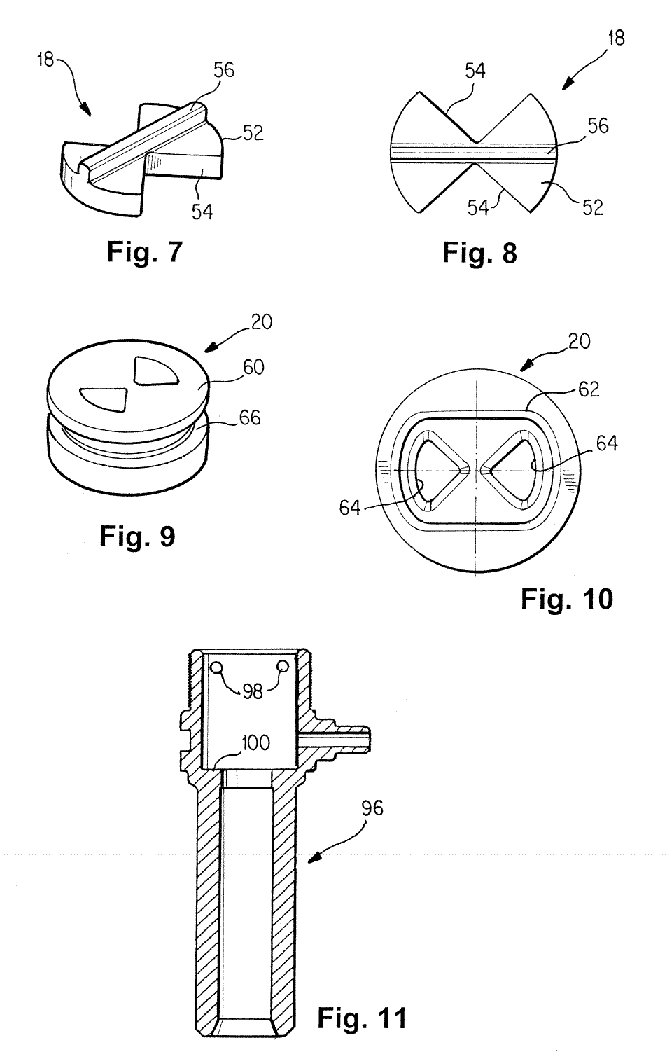

The upper ceramic disk 18, as illustrated in FIGS. 7 and 8, includes a plate 52 that defines a pair of diametrally opposed cutouts 54 and a ridge 56 extending between the cutouts 54. The ridge 56 operatively engages the diametral slot 50 of the valve stem 16. When the ridge 56 engages the slot 50, the cutouts 54 are aligned with the recesses 48 of the valve stem 16. The cutouts 54 and recesses 48 combine to form a water passage for selectively directing water out of the cartridge 10 through the outlet openings 36.

The lower ceramic disk 20, illustrated in FIGS. 9 and 10, includes a plate 60 having a race track-shaped recess 62 in the bottom thereof and a pair of triangular water passages 64 formed in the recess 62 and extending through the plate 60. The plate 60 further includes an o-ring groove 66 formed in the peripheral edge 68 thereof.

The spring guide 22 includes a base plate 70 and a blade portion 72 extending downwardly from the base plate 70. A projection 74 extends upwardly from the base plate 70 and is configured to engage the recess 62 formed in the lower disk 20. Two water passages 76 extend through the plate 70. The blade portion 72 is sized to fit in the notches 43 formed in the base wall 32 of the housing body 12 to rotationally lock the blade portion 72 relative to the housing body 12. The interaction between the projection 74 and the recess 62, in turn rotationally locks the lower ceramic disk 20 relative to the housing body 12.

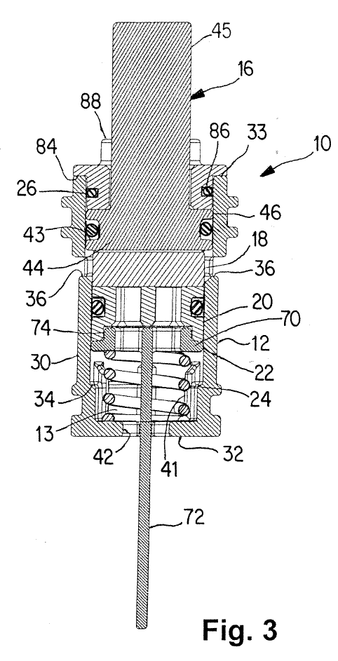

The lower ceramic disk 20 and the housing body 12 form a chamber 13 therebetween, as illustrated in FIG. 3. The spring 24 is disposed in the chamber 13 and rests on the base wall 32 of the housing body 12. It is supported in position by the bosses 41 formed on the side wall 30. The blade portion 72 of the spring guide 22 fits closely inside the spring 24 to help maintain proper alignment of the spring 24 in the housing body 12. The spring 24 operatively biases the lower ceramic disk 20 against the upper ceramic disk 18 to provide a sealing engagement between the upper and lower disks. As the water pressure increases, the lower ceramic disk 20 is driven with increasing force against the upper ceramic disk 18.

The housing top 14 includes a base plate 80 and a cylindrical side wall 82 depending from the base plate 80. The base plate 80 extends radially outwardly from the cylindrical side wall 82 forming a shoulder 84. The cylindrical side wall 82 further includes a pair of slots 86. When the housing top 14 is operatively positioned on the housing body, the shoulder 84 operatively abuts the top of the cartridge housing side wall 30, while the bottom of the side wall 82 abuts the valve stem 16, and the slots 86 operatively align with the retaining clip-receiving bores 38 to receive the retaining clip 26.

A pair of stopping bosses 88 extend upwardly from the base plate 80 to provide stops to limit the movement of the faucet handle (not shown) between an open and closed position. The stopping bosses 88 are configured to allow the handle (not shown) to skip over the bosses 88 if too much pressure is applied to the handle by the user without damaging the bosses 88.

In addition to other novel features, the lower ceramic disk 20 of the present cartridge 10 is sealed within the housing body 12 in a unique way as compared to conventional ceramic cartridges. In a conventional ceramic cartridge, the lower ceramic disk would sit on top of a rubber compression seal. When the cartridge is assembled, the compression seal compresses, thereby driving the ceramics together and simultaneously forming a seal between the lower ceramic disk and the base wall of the housing body. Unfortunately, over time, the plastic in the housing body relaxes, causing the compression seals to lose compression and allow undesirable leakage.

In the present cartridge, the lower ceramic disk 20 has an o-ring groove 66 cut into it, which uses an o-ring to seal radially against the housing body 12. The use of an o-ring to seal the lower ceramic disk 20 eliminates the need to compress one element of a typical design and reduces the possibility of leakage.

The cartridge outer housing follows a similar concept. For example, as shown in FIG. 1, o-ring seals 90, 92 are positioned to seal against an underbody (not shown). This is especially critical in the case where the underbody is made of plastic, as would be the case in a lead-free faucet. In conventional cartridges, a rubber compression seal would be used to provide a seal between the housing and the underbody. However, in the case of the plastic underbody, this seal would tend to lose compression over time as the plastic relaxes. The present cartridge completely avoids the problem by using O-rings instead of compression seals.

Moreover, conventional cartridges use a threaded valve cap that screws onto a threaded underbody to hold the cartridge in place while applying a compressive force to a compression seal disposed between the base wall of the cartridge and the underbody. Advantageously, the use of o-ring seals 90, 92 in the present cartridge 10 eliminates the need for an expensive threaded valve cap, allowing the use of an inexpensive retaining clip to retain the cartridge in the underbody. As illustrated in FIG. 11, an underbody 96 of the type to be used with the present cartridge can incorporate a pair of through bores 98 to receive a retaining clip similar to retaining clip 26. The retaining clip can rest against the housing top 14 when the cartridge 11 is disposed in the underbody 96. Thus, the cartridge is allowed to “float” inside the underbody. That is, there is no conventional compression seal between the cartridge and the base wall 100 of the underbody. In conventional cartridge/underbody combinations, floating would cause leaks and would, therefore, be unacceptable. However, in the present cartridge, the ability to float reduces the need to maintain tight tolerances within the underbody, which reduces manufacturing costs.

Another novel feature is the spring guide 22, which also acts as assembly aid. Dropping small components, such as the spring 24 and lower ceramic disk 20, into the top of the valve housing presents a manufacturing challenge. The blade portion 72 of the spring guide 22, in addition to keeping the spring 24 straight, facilitates the manufacturing process by allowing the spring 24 and lower ceramic disk 20 to be inserted into the housing 12 as a subassembly. The blade portion 72, by cooperating with the notches 43, also keeps the lower ceramic disk 20 rotationally “keyed” to the valve housing, such that only the upper ceramic disk 18 rotates with the valve stem 16.

Another feature of the present cartridge is that the valve can rotate a full 360 degrees. Thus, at 0 degrees the valve is fully closed; at 90 degrees it is fully opened; at 180 degrees it is fully closed again; and at 270 degrees it is fully opened again. Typically, this arrangement is undesirable, and conventional cartridges limit movement to between 0 and 90 degrees. In conventional cartridges, this is accomplished by creating a “stop” between the valve stem and outer housing, typically by forming bosses on the inside of the cartridge wall. However, this can load the valve stem unnecessarily, possibly breaking it if the customer applies enough force to the stop. For this reason, the present cartridge does not use an interior stop, as in conventional cartridges. Instead, the stop is moved to a position between the handle and the underbody by using the stopping bosses 88 on the housing top 14. The handle will “skip” if too much force is applied, and can be returned to normal function by driving it back over the “skip”. If this is not possible, the handle will be sacrificial, since the handle is easier to replace than the cartridge.

The above-described embodiments, of course, are not to be construed as limiting the breadth of the present invention. Modifications and other alternative constructions will be apparent that are within the spirit and scope of the invention as defined in the appended claims.

1. A cartridge valve comprising:
a housing body having a base wall and a cylindrical side wall extending from the base wall;
an upper ceramic disk disposed in the housing body;
a lower ceramic disk disposed in the housing body; and
a chamber defined by the lower ceramic disk, the base wall and at least a portion of the cylindrical side wall, wherein water is allowed to fill the entire chamber.

2. The cartridge valve of claim 1 further comprising a spring disposed in the chamber.

3. The cartridge valve of claim 1 wherein the lower ceramic disk further includes means for sealing the chamber.

4. The cartridge valve of claim 3, wherein the means for sealing includes a groove formed in an outer peripheral edge of the lower ceramic disk and an o-ring disposed in the groove.

5. The cartridge valve of claim 1 further comprising means for rotationally locking the lower ceramic disk to the housing body.

6. The cartridge valve of claim 5 wherein the means for rotationally locking includes a spring guide disposed in the chamber and configured to engage the base wall.

7. In combination with an underbody, a cartridge valve disposed in the underbody and comprising:
a housing having a housing top; and
a first retaining clip, wherein the underbody includes means for receiving the first retaining clip, the retaining clip abutting the housing top to retain the cartridge in the underbody when received in the means for retaining.

8. The cartridge valve of claim 7 wherein the cartridge and underbody are sized and configured to allow the cartridge to float in the underbody.

9. The cartridge valve of claim 7 further including a housing body having a base wall, wherein the underbody further includes a base wall and a side wall, the cartridge housing base wall cooperating with the underbody base wall and side wall to form a chamber, wherein the entire chamber is open to water.

10. A cartridge valve comprising:
a housing body;
a housing top coupled to the housing body;
an upper ceramic disk disposed in the housing body;
a lower ceramic disk disposed in the housing body; and
a spring disposed between the lower ceramic disk and the housing body.

11. The cartridge valve of claim 10 wherein the lower ceramic disk includes an o-ring groove formed in an outer peripheral edge thereof and an o-ring disposed in the o-ring groove.

12. The cartridge valve of claim 10 further comprising a retaining clip, wherein the housing body further includes first means for receiving the retaining clip and the housing top further includes second means for receiving the retaining clip.

13. The cartridge valve of claim 10 further including an underbody for receiving the cartridge valve and a retaining clip for retaining the cartridge valve in the underbody.

14. The cartridge valve of claim 10 further including a spring guide disposed in the housing body and including a blade portion for engaging the spring and the housing body.

15. The cartridge valve of claim 10 wherein the housing top includes at least one stop for controlling the amount of rotation of a faucet handle coupled to the cartridge.
